(19) United States
(12) Patent Application Publication
(10) Pub. No.: US 2019/0303395 A1
(43) Pub. Date: Oct. 3, 2019

(54) TECHNIQUES TO DETERMINE PORTFOLIO RELEVANT ARTICLES

(71) Applicant: State Street Corporation, Boston, MA (US)

(72) Inventors: Brendan Flood, Boston, MA (US); Daniel Huss, Boston, MA (US); Abhishek Kodi, Boston, MA (US); Stephen Marshall, Boston, MA (US); Kevin Robinson, Boston, MA (US); Rajeev Sambyal, Boston, MA (US); Gurraj Sangha, Boston, MA (US); Sameera Somisetty, Boston, MA (US)

(73) Assignee: State Street Corporation, Boston, MA (US)

(21) Appl. No.: 16/370,307

(22) Filed: Mar. 29, 2019

Related U.S. Application Data
(60) Provisional application No. 62/650,468, filed on Mar. 30, 2018.

(51) Int. Cl. G06F 16/36; G06F 17/27; G06F 16/957; G06F 16/35; G06K 9/62

(52) U.S. Cl. CPC G06F 16/367; G06F 17/278; G06Q 40/06; G06F 16/355; G06K 9/6232; G06F 16/9574

(57) ABSTRACT

Techniques to determine portfolio relevant articles are described. In one embodiment, an apparatus may comprise a priority model engine operative to analyze an article to generate a priority model score; an entity recognition engine operative to determine one or more entities mentioned in the article; an ontology engine operative to match the one or more entities to one or more investment holdings; determine a portfolio related to the one or more entities; a connection and risk engine operative to determine a connection-risk score for the article as it relates to the portfolio; and a score server operative to generate a final score for the article based on the priority model score and the connection score; and determine whether to provide the article to a user associated with the portfolio based on the final score. Other embodiments are described and claimed.

### RELATED APPLICATIONS

This application claims the benefit of priority under 35 U.S.C. § 119(e) to U.S. Provisional Patent Application No. 62/650,468 filed Mar. 30, 2018 which is hereby incorporated by reference in its entirety.

### BACKGROUND

Investors may maintain portfolios of various holdings that comprise their investments. Investors may stay informed about their investment portfolio by consuming news articles related to their holdings. These news articles may be distributed via the Internet via web sites, RSS feeds, email subscriptions, or any other technique. These news articles may be viewed on computer devices by investors.

### SUMMARY

The following presents a simplified summary in order to provide a basic understanding of some novel embodiments described herein. This summary is not an extensive overview, and it is not intended to identify key/critical elements or to delineate the scope thereof. Some concepts are presented in a simplified form as a prelude to the more detailed description that is presented later.

Various embodiments are generally directed to techniques to determine portfolio relevant articles. Some embodiments are particularly directed to determine portfolio relevant articles for investors based on automated priority recognition, entity recognition, and risk recognition. In one embodiment, for example, an apparatus may comprise an ingestion engine operative to receive an article; a priority model engine operative to analyze the article with a priority model to generate a priority model score, the priority model comprising a supervised learning model trained on curated articles; an entity recognition engine operative to determine one or more entities mentioned in the article; an ontology engine operative to match the one or more entities to one or more investment holdings based on an ontology model; determine a portfolio related to the one or more entities; a connection and risk engine operative to determine a connection-risk score for the article as it relates to the portfolio, the connection-risk score reflecting the connection of the article to the portfolio and a portfolio risk of the one or more entities to the portfolio; and a score server operative to generate a final score for the article based on the priority model score and the connection score; and determine whether to provide the article to a user associated with the portfolio based on the final score. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of an article curation system.

FIG. 2 illustrates an embodiment of an article curation system arranged for processing an article.

FIG. 3 illustrates an example of a processing flow describing data ingestion.

FIG. 4 illustrates an example of a processing flow for publishing topics.

FIG. 5 illustrates an example of a processing flow to determine final scores.

FIG. 6 illustrates an example of a score transparency user interface.

FIG. 7 illustrates an example of a direct connections user interface.

FIG. 8 illustrates an embodiment of a network effect user interface.

FIG. 9 illustrates an embodiment of a centralized system for the system of FIG. 1.

FIG. 10 illustrates an embodiment of a distributed system for the system of FIG. 1.

FIG. 11 illustrates an embodiment of a computing architecture.

FIG. 12 illustrates an embodiment of a communications architecture.

### DETAILED DESCRIPTION

Various embodiments are directed to utilizing a user's portfolio and assets to find related news articles, e.g., using portfolio metrics to suggest news articles that are of interests to the user. The news articles may be located via an Internet search using keywords generated from the portfolio. The results, e.g., the returned articles are put through a number of processing elements and may be ranked based on a number of factors, such as relevance between the article and its content and the associated asset in the portfolio. Further, a score may be generated based on the article, relevance, risk, holdings, amount of holdings, and other asset related values. The score may be used to surface articles that are related directly and indirectly to assets in a user's portfolio.

In addition to ranking the news articles, the score results also have been shown to be a predictive quality in determining volatility for the associated asset. As such, users may be shown score results that represent not only the relevance to the user of the associated article but that themselves represent relevant information about a particular holding. For example, a user may be shown a score of 8 for an article that not only indicates that the article is relevant to the user, while also indicating that the asset has 14%-18% volatility 60% of the time, or other specific volatility metrics.

In general, users may be promoted articles that better inform them about their investments. The scope of the data analyzed by the system may exceed that available to human curators performing manual curation and that may be applied with a specificity to the contents of each user's portfolio that would be impractical with manual curation. As such, the enclosed techniques may provide a depth of analysis of article relevance that exceeds that of manually-curated feeds. As a result, the embodiments can improve affordability, scalability, extendibility, and quality of news article curation for an operator, device or network. These and other details will become more apparent in the following description.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

It is worthy to note that “a” and “b” and “c” and similar designators as used herein are intended to be variables representing any positive integer. Thus, for example, if an implementation sets a value for a=5, then a complete set of components 122 illustrated as components 122-1 through 122-a may include components 122-1, 122-2, 122-3, 122-4 and 122-5. The embodiments are not limited in this context.

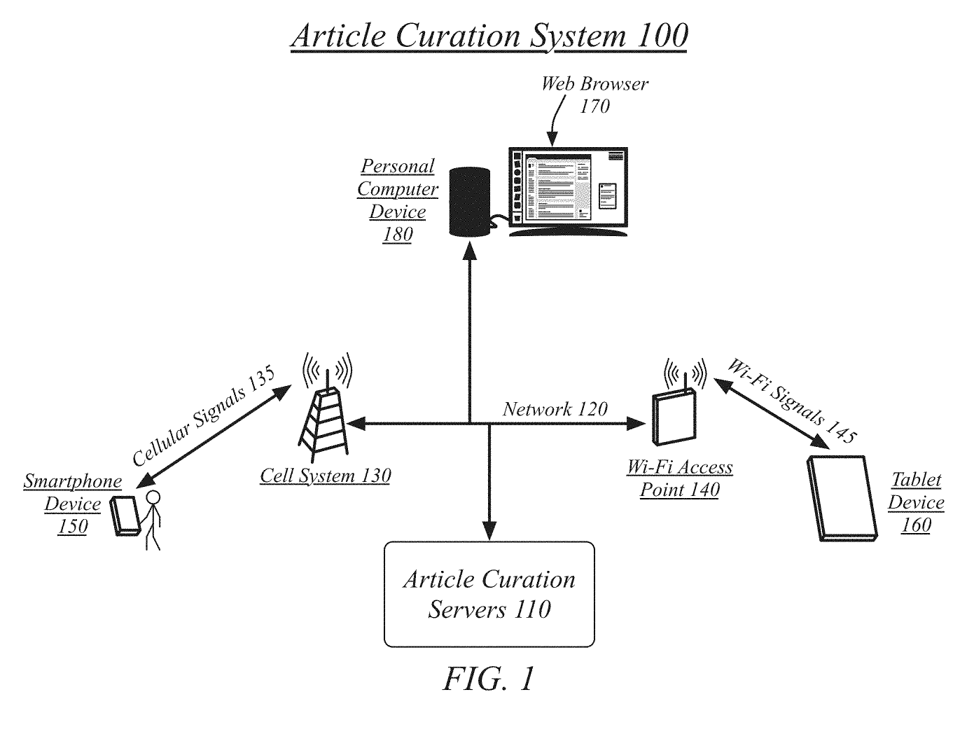

FIG. 1 illustrates a block diagram for an article curation system 100. In one embodiment, the article curation system 100 may comprise a computer-implemented system having software applications comprising one or more components. Although the article curation system 100 shown in FIG. 1 has a limited number of elements in a certain topology, it may be appreciated that the article curation system 100 may include more or less elements in alternate topologies as desired for a given implementation.

Article curation servers 110 may comprise one or more servers operated by an article curation platform as part of an article curation system 100. An article curation server may comprise an Internet-accessible server, with the network 120 connecting the various devices of the article curation system 100 comprising, at least in part, the Internet. An article curation system 100 may use the article curation servers 110 to support article curation and portfolio analysis for various user client devices.

A user may own and operate a smartphone device 150. The smartphone device 150 may comprise an iPhone® device, an Android® device, a Blackberry® device, or any other mobile computing device conforming to a smartphone form. The smartphone device 150 may be a cellular device capable of connecting to a network 120 via a cell system 130 using cellular signals 135. In some embodiments and in some cases the smartphone device 150 may additionally or alternatively use Wi-Fi or other networking technologies to connect to the network 120. The smartphone device 150 may execute a portfolio client, web browser, or other local application to access the article curation servers 110.

The same user may own and operate a tablet device 160. The tablet device 160 may comprise an iPad® device, an Android® tablet device, a Kindle Fire® device, or any other mobile computing device conforming to a tablet form. The tablet device 160 may be a Wi-Fi device capable of connecting to a network 120 via a Wi-Fi access point 140 using Wi-Fi signals 145. In some embodiments and in some cases the tablet device 160 may additionally or alternatively use cellular or other networking technologies to connect to the network 120. The tablet device 160 may execute a portfolio client, web browser, or other local application to access the article curation servers 110.

The same user may own and operate a personal computer device 180. The personal computer device 180 may comprise a Mac OS® device, Windows® device, Linux® device, or other computer device running another operating system. The personal computer device 180 may be an Ethernet device capable of connecting to a network 120 via an Ethernet connection. In some embodiments and in some cases the personal computer device 180 may additionally or alternatively use cellular, Wi-Fi, or other networking technologies to the network 120. The personal computer device 180 may execute a portfolio client, web browser 170, or other local application to access the article curation servers 110.

A portfolio client may be a dedicated investment management client. A dedicated investment management client may be specifically associated with an investment company administering the article curation servers 110. Alternatively, the investment company may be accessed via the web, with the portfolio client comprising a general-purpose web browser.

A client for viewing curated news articles may be a component of an application providing additional functionality. For example, a portfolio management client or portfolio management web page may empower a user to view their current investments, to make changes to their investments, such as in response to a news article provided to them, or any other portfolio-related task.

The article curation system 100 may use knowledge generated from actions performed by users. As such, to protect the privacy of the users of the article curation system 100 and the larger investment service, article curation system 100 may include components that allows users to opt in to or opt out of having their actions logged by the article curation system 100, for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers or other authorization components may enforce one or more privacy settings of the users of the article curation system 100 through blocking, data hashing, anonymization, or other suitable techniques as appropriate.

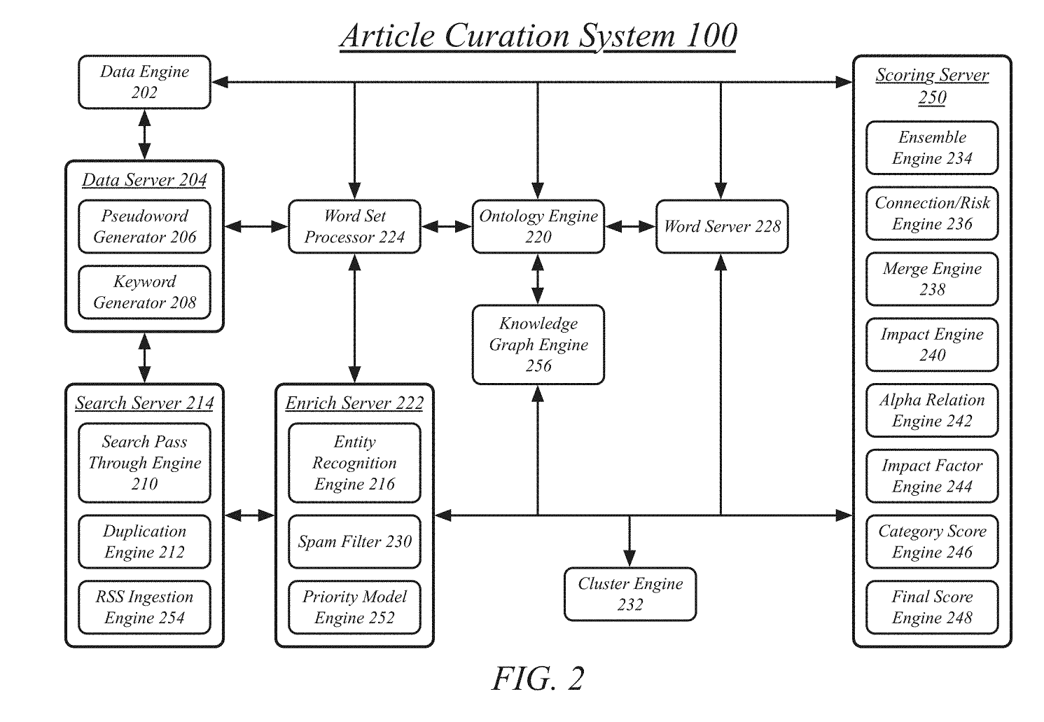

FIG. 2 illustrates a block diagram for an article curation system 100. In one embodiment, the article curation system 100 may include one or more components. Although the article curation system 100 shown in FIG. 2 has a limited number of elements in a certain topology; it may be appreciated that the article curation system 100 may include more or fewer elements in alternate topologies as desired for a given implementation. In embodiments, the system includes a servers, engines, data stores, and components coupled via one or more interconnections, such as one or more network connections. The article curation system 100 may include one or more processing units, storage units, network interfaces, or other hardware and software elements, described in more detail below.

In an embodiment, each component may include a device, such as a server, comprising a network-connected storage device or multiple storage devices, such as one of the storage devices described in more detail herein. In an example, article curation system 100 includes one or more the components and may include one or more devices used to access software or web services provided by servers. In various embodiments, article curation system 100 and the components of article curation system 100 may include or implement multiple other components or modules. As used herein the terms “component” and “module” are intended to refer to computer-related entities, comprising either hardware, a combination of hardware and software, software, or software in execution. For example, a component and module can be implemented as a process in the form of code for execution by processor circuitry of one or more processors or processor cores, hardcoded logic in circuitry, and/or by a computer. The code may be stored on a hard disk drive, multiple storage drives (of optical and/or magnetic storage medium), and/or the like and may be stored in the form of an object, an executable, a thread of execution, a program, and/or the like. By way of illustration, both an application stored for execution on a server and the server can be a component and/or module. One or more components and/or modules can reside within a process and/or thread of execution, and a component and/or module can be localized on one computer and/or distributed between two or more computers as desired for a given implementation. The embodiments are not limited in this context.

The various devices within article curation system 100, and components and/or modules within a device of article curation system 100, may be communicatively coupled via various types of communications media as indicated by various lines or arrows. The devices, components and/or modules may coordinate operations between each other. The coordination may involve the uni-directional or bi-directional exchange of information. For instance, the devices, components and/or modules may communicate information in the form of non-transitory signals communicated over the communications media. The information can be implemented as signals allocated to various signal lines. In such allocations, each message is a signal. Further embodiments, however, may alternatively employ data messages. Such data messages may be sent across various connections. Exemplary connections within a device include parallel interfaces, serial interfaces, and bus interfaces. Exemplary connections between devices may include network connections over a wired or wireless communications network.

In various embodiments, the components and modules of the article curation system 100 may be organized as a distributed system. A distributed system typically includes multiple autonomous computers that communicate through a computer network. The computers interact with each other in order to achieve a common goal, such as solving computational problems. For example, a computational problem may be divided into many tasks, each of which is solved by one computer. A computer program that runs in a distributed system is called a distributed program, and distributed programming is the process of writing such programs. Examples of a distributed system may include, without limitation, a client-server architecture, a 3-tier architecture, an N-tier architecture, a tightly-coupled or clustered architecture, a peer-to-peer architecture, a master-slave architecture, a shared database architecture, and other types of distributed systems. It is worthy to note that although some embodiments may utilize a distributed system when describing various enhanced techniques for data retrieval, it may be appreciated that the enhanced techniques for data retrieval may be implemented by a single computing device as well. The embodiments are not limited in this context.

In embodiments, the article curation system 100 may include one or more components to receive and/or collect data, generate one or more keywords related to the collected data, and utilize the keywords to search for related articles, discussions, news, social media content, opinion content and so forth. Embodiments further include the article curation system 100 filtering the results to identify the most relevant article results according to a portfolio, e.g., as the user's investing holding and assets. The system may enrich the most relevant results by determining a number of the most relevant keywords from the results and weights related to the most relevant articles. Further, the article curation system 100 may rank the insight, e.g., the relevant keywords and weights based on relevance to a portfolio impact. In some embodiments, the article curation system 100 may determine vector distances between the information in the articles and the portfolio asset names. These vector distances may be utilized to generate a score or prediction based on training with one or more models, e.g., an ensemble of models. The article curation system 100 may utilize the score to refine further the news articles related to assets currently being held in a portfolio, directly and indirectly. These and other details will become apparent in the following description.

In embodiments, the article curation system 100 may include a data processing engine 202 that is capable of collecting information and data. In embodiments, the data processing engine 202 may be coupled to one or more data stores or databases and collect data associated with a portfolio for a customer for further analysis. The data may include portfolio data, individual holdings, data associated with the individual holdings or assets, e.g., allocations, value at risk (VaR), beta data, and so forth. Moreover, the data may include asset ticket symbols and company names associated with the portfolio. Embodiments are not limited in this manner. In embodiments, the data processing engine 202 may provide the data and information to one or more other systems for further processing.

In embodiments, the article curation system 100 further includes a data server 204 that may further process the data. More specifically, the data server 204 may be utilized to determine pseudowords or words associated each of the assets in the portfolio. More specifically, the data server 204 may include a pseudoword generator 206 to generate one or more pseudowords for each of the assets in the portfolio. Each of the assets and pseudowords may be processed to generate one or more keywords by a keyword generator 208. These keywords may be contextually similar keywords relating to the assets. In one example, the keyword generator 208 may utilize one or more models, such as a Word2Vec model that may be similar to a Continuous Bag-of-Words model (CBOW), a Skip-Gram model, and so forth to generate the contextually similar words to the companies or assets in a portfolio. The model may be trained using historical data and information from sources such as the Wall Street Journal (WSJ), CNBC, Bloomberg, Wikipedia, and so forth.

In embodiments, the article curation system 100 including the data server 204 may provide the keywords associated with the portfolio to a search server 214. The search server 214 may include a number of components that may be utilized to search for articles based on the keywords. For example, the search server 214 may include a search pass through engine 210 which may be utilized to input the keywords into a search engine application programming interface (API) to generate search results based on the keywords as a keyword search. The search engine API may be associated with any search engine, such as Bing®, Google®, Yahoo®, and so forth. Moreover, in the target news search case, the news is searched using targeted search words which encapsulate each holding. These set of targeted searches bring in the relevant news in the context of a portfolio and its related topics. In some embodiments, 50 articles may be obtained for each keyword generated for a portfolio. However, embodiments are not limited in this manner, and the number of articles may be predefined and/or user-defined.

The search pass through engine 210 may receive a number of results or articles based on the searched keywords which may be further processed. These received results or articles comprise candidate articles for evaluation by the article curation system 100. For example, the results may pass through a duplication engine 212 to detect any duplicating articles and to remove those articles from a database storing articles. In one example, the duplication engine 212 may remove duplicating articles based on check-sum indexing. For example, a check-sum may be generated for each article and may be used to index the article in a database via a checksum indexing. Thus, duplicate articles can be detected based on having the same check-sum value as their index. The duplicated articles may be discarded by the duplication engine 212 if a matching index is already found in the check-sum index in the database. Articles that are not duplicated are then analyzed for portfolio relevance using the techniques described herein.

In embodiments, the search server 214 may receive one or more articles via a push mechanism. For example, the search server 214 includes a rich site summary (RSS) ingestion engine 254 that receives articles from one or more channels, e.g., news websites, financial news websites, financial informational websites, associated press, Thompson Reuters news feeds, and so forth. The one or more channels may be user-selected and/or computer-selected based on relevancy to portfolio holders. Moreover, the RSS ingestion engine 254 may adjust, e.g., add/remove channels, based on a user input and/or a change in relevancy detected by the RSS ingestion engine 254. For example, the ingestion engine 254 may receive an indication and/or determine that a channel is no longer providing relevant information. Similarly, the ingestion engine 254 may receive an indication and/or make a determination that a new channel is available and to add the new channel. Embodiments are not limited to these examples.

In embodiments, the RSS ingestion engine 254 receive the one or more articles from the one or more channels on a periodic, semi-periodic, and/or non-periodic basis. Moreover, the RSS ingestion engine 254 may receive the one or more articles from different channels at the same time or at different times. In embodiments, the search server 214 may run a job to cause the ingestion processes, e.g., searching and/or rss ingestion. Based on the portfolio nature and news volume, jobs are run in regular time periods of 0.5 hrs to 2 hrs intervals, non-periodic, and/or semi-periodic. The jobs are dynamic and customizable.

In embodiments, the article curation system 100 may include an enrich server 222 to further process the articles. The enrich server 222 including the entity recognition engine 216 may further process each of the articles to determine one or more entities in the articles, such as names of people, places, company names. In one example, the entity recognition engine 216 may using a tagging function to intelligent locate and tag each of the entities within an article. In some embodiments, the enrich server 222 may include an entity augmentation engine to perform a secondary name entity recognition based on parse trees of the articles. The enrich server 222 may add subjects into the assimilated named entity recognizer (NER). Moreover, the enrich server 222 may remove irrelevant words using the language parse trees to detect non-pertinent entities and isolate them from the articles. For example, the article having the highly relevant entities returned by the NER is not the primary subject of the article. Using the spaCy trees, such entities are flagged and/or removed. These operations may be performed based on the data received from the search server 214. For example, the enrich server 222 may receive the data with tags from a news source of the one or more channels, e.g., utilizing Thompson Reuters intelligent tagging platform. In case of the RSS feed, the enrich server 222 may receive an article identifier. However, articles received from a search may include the Title and Description for an intelligent tagging process performed by the enrich server 222.

In embodiments, the enrich server 222 including the entity recognition engine 216 may determine the contextual weightage of the extracted entity (NER) words. Based on the placement of NER words in the content weights are applied to NER relevance score to produce top-n performing words. In on example, the weights are as follows: Title (weight of 2), Description (weight of 0.85), and Text but not description (weight of 0.6). In embodiments, the weighting may include differential weighting of the NER words to determine the top pertinent entities.

In embodiments, the enrich server 222 also includes a spam filter 230 and a priority model engine 252. The spam filter 230 may determine whether an article is a spam or not spam. For example, the spam filter 230 may ingest content (article) and tag it as spam or not spam. In one example embodiment, the spam filter 230 is a Naive Bayes driven, text features based supervised learning model with probabilistic estimations of the spam articles. In some embodiments, the spam filter 230 enables editors to have the ability to highlight spam ‘words’ in article headlines and descriptions. The spam filter 230 may perform machine learning and may improve over time with the goal of reducing spam articles to <5%. Models are updated in consistent time intervals, and the spam filter 230 may perform applied metric tracking.

In embodiments, the enrich server 222 includes a priority model engine 252 to ingest the articles and tag the articles with a priority score. For example the priority model engine 252 may tag each article with a priority model score. In one example, the priority model engine 252 utilizes a supervised learning model trained on curated articles over time to efficiently contrast between relevant and impactful articles. In some embodiments, the priority model engine 252 may enable a user to provide feedback, e.g., thumbs up and thumbs down, to improve the article. The priority model engine 252 may update models inconsistent time intervals. Further, the priority model engine 252 may also perform applied metric tracking. The priority model engine 252 may receive user article evaluation metrics from user interactions with displayed articles and update the priority model based on the received user article evaluation metrics using machine learning techniques.

In embodiments, the article curation system 100 includes a word set processor 224 that may collect and/or receive one or more word sets. For example, the word set processor 224 may get a first word set from the data server 204. The first-word set may be a portfolio centric word set and may include an asset company name, ticker symbol, an allocation, VaR information, beta information, and so forth. In embodiments, the word set processor 224 may collect a second word set from the enrich server 222, which includes the article centric word set, e.g., NER words, entities, concepts, and keywords. In embodiments, the word set processor 224 may include one or more databases to store this information for further processing. Further, the word set processor 224 may store/provide the word sets to the ontology engine 220 and the word server 228 for further processing, for example. More specifically, the article curation system 100 includes an ontology engine 220 to iterate the article centric word set including the entities over the ontology and cross compare to determine direct mention or indirect mention of the holdings in a particular portfolio and the entities in the article. The ontology engine 220 may also provide a relation weightage based on the iteration.

In embodiments, the ontology engine 220 may receive information and/or perform one or more operations in conjunction with a knowledge graph engine 256. More specifically, the knowledge graph engine 256 may encapsulate dynamic Ontology data from the ontology engine 220 which is continuously updated with multiple aliases of entities (i.e., entity aliases) and relationship types such as parent companies (i.e., parent company relationships), new relationships, senior executive relationships (e.g., a mapping of senior officers of a company), etc. The knowledge graph engine hosts Factset supply chain data which is employed in executing a network and return correlation evaluation executed in the scoring pipeline based on the FactSet data. In embodiments, the article curation system 100 including the knowledge graph engine 256 may use equation 2 to determine a relationship strength:

Relationship_{ab}=( [symbol] *tan h(Σ( [symbol] * [symbol] )+Σx_{ab}*μ))+ [symbol] *(Ω_{ab}), (1).

In embodiments, [symbol] is a connection type weight factor, [symbol] is a number of connection of a type, [symbol] is a relationship type, x is a number of shared common relationship, [symbol] is proportionality constant, [symbol] is the return correlation between company a and company b, [symbol] is the network proportionality constant, and [symbol] is the correlation proportionality constant. Further, equation 2, below, may be used to determine the total relationship:

Total Relationship=Σ_{ab}(Relationship_{ab}*η), (2).

In embodiments, η is the scaling and proportionality constant. Moreover and in embodiments, the knowledge graph engine 256 may use equations 2 and 2 to determine direct relationships (Competitor/Supplier/Customer/Sector/Industry) and first level shared(common) relationship. Among the relationships, the top 5 relationship are valued primarily utilizing the top 20 ranked set of relationships. The Relationships between holdings in a portfolio are ordered and combining most pertinent relations are utilized to surface indirect holdings pertinent to the articles. Embodiments are not limited in this manner. Relationships may be expanded beyond direct relationships to include relationships at multiple degrees of separation.

In embodiments, the article curation system 100 includes a word server 228 to process one or more word sets. For example, the word server 228 may collect the first-word set and the second word set from the word set processor 224 and cross compare the word sets to determine the relationship between the portfolio and the entities from the articles. In embodiments, the word server 228 including a word-to-vector (W2V) distance engine may use the W2V model previously utilized to generate keywords to calculate vector distances between every asset (company/ticker symbol) in the portfolio and the article entities. In embodiments, the W2V distance engine may determine most relevant entities and associated articles based on the calculated distances. More specifically, the scoring performed by the word server 228 may determine which assets are most relevant to an article. The scoring surfaces articles with the 2^{st}, 2^{nd}, and 3^{rd} order of importance to the assets, for example. In embodiments, the output of the word server 228 may indicate the top articles for each of the assets to the scoring server 250.

In another example, the word server 228 determines or gets the words sets from articles and portfolios and cross-compares for considerable relationships between holdings and articles. For example, the word server 228 may determine a Cosine distance between the holdings and the article word sets to establish connections. Moreover, an Ensemble of word embedding models are utilized, wherein the multiple models are trained on different corpora to minimize data loss and optimize relationship capture. More specifically, the word server 228 may use word embedded models (2× Models from Wall Street Journal, 2× Models from Wikipedia data, 2× Models from Google News, and 2× Model from Historical Thompson Reuters News), to determine relationships. Moreover, the pertinent entities for an article pass into the word set processor 224 and passed through the ontology Engine 220 and the word server 228 to connect the article to holdings in respective portfolios. The connection strengths obtained for an article with respect to a portfolio is then utilized to evaluate Connection Strength of the article to the portfolio leading to its relevance to the respective portfolio.

In embodiments, the article curation system 100 includes a scoring server 250 may process data and determine final scores for articles. In embodiments, the final score or (V-score) is composed of three unequally-weighted components which have been determined to provide a quantitatively-derived optimum newsfeed of articles relevant and impactful to a portfolio. The weight of each component and the methodology used to combine the three components is determined after comprehensive and consistent testing of these components, their weights, and parameters. The three components of the final score is connection and risk, content, and network. News articles which have been surfaced, via a machine learning algorithm as previously discussed, reflect those for which there is a direct or indirect connection to a portfolio's holdings. The vast majority of surfaced articles contain anchor holdings, which are portfolio holdings for which there is a strong, quantitatively determined, connection to an article. A smaller percentage of surfaced articles, do not have anchor holdings, as none of the holdings in a portfolio are strongly connected to an article. In embodiments, the scoring server 250 may determine a minimum threshold that needs to be reached, by an article's connection and risk component, before the other components are calculated and combined to compose the V-score or final score. Each component of the V-score individually addresses a unique aspect of an article's impact on the portfolio.

In embodiments, the connection and risk component (connection score) reflects the connection of an article to a portfolio, adjusted for portfolio's risk. This component is the most sensitive of the 3 components of the V-score, and is computed using the portfolio risk metrics, ontology and word-vector relationships between an article and the entities in a portfolio (which are categorized as anchor holdings). In one example, the connection and risk component may be a scaled, aggregated (Anchor connection strength)+weighted VaR value and based on other operations performed by the scoring server 250.

In embodiments, the content component (priority model score) is computed, independently of the other components, and is driven by a supervised machine learning model which continuously evolves with curation feedback and aims to order the content in order of highest potential impact. This is a continuously improving process, which predominantly elevates articles with impactful content over relevant content. In embodiments, the content component is a Bayesian probabilistic content score or priority model score, e.g., determined by the priority model engine 252.

In embodiments, the network component addresses the aggregate centrality and influence of the anchor holdings. It's driven by the portfolio structure (price return correlation) and the potential pervasiveness of an anchor holdings influence (network correlation). In one example, the network component may be a normalized aggregated (Network centrality+price/risk correlation) value, e.g., a network and process correlation score.

In embodiments, the final score may be calculated by equation 3:

Final Score=λ(α*(connection score)+β*(priority model score)+γ*(network and price correlation score) (3).

In embodiments α is the connection strength proportionality constant, β is the priority model strength proportionality constant, and γ is the network strength proportionality constant. Moreover, the connection score may be generated and provided by the knowledge graph engine 256, the priority model score may be generated by the priority model engine, and the network and price correlation score may be generated by the scoring server 250. Embodiments are not limited in this manner.

In embodiments, the scoring server 250 may include one or more components to process the data and generate the information including the network and price correlation score. In embodiments, the scoring server 250 includes an ensemble engine 234 to ascertain relationships from the data generated by the ontology engine 220 and the word server 228 and assimilate to utilize optimum connections. The scoring server 250 includes a connection and risk engine 236 to determine the optimized connection strengths for holding(s) per article. The connection and risk engine 236 may apply a risk model to weigh articles via a combination of portfolio analytics. For example, the connection and risk engine 236 may translate each holdings VaR into a proportion of portfolio VaR, which may be used by the risk model. Other risk factors from TruView® may be applied to by the risk engine to weigh the news. In embodiments, the scoring server 250 includes a merge engine 238 to calibrate the risk scores over the connection strengths for pertinent connection scores. Moreover, the pertinent connection scores and risk scores are merged by the merge engine. In embodiments, the merge engine 238 may redistribute the calibrated merged values along a logarithmic scale and then scaled by 4 to increase sensitivity.

The scoring server 250 includes an impact engine 240 to determine a set of impact values from the pipeline and are not specific to an asset an article. They are specific at a word level and may be used inputs to the connections model. Moreover, the impact engine 240 determines an array of valuable impacts which are above a tunable threshold that is currently set at 0.6, but may be user/computer adjusted. The impact engine 240 evaluates the network relationships for the holding above a certain threshold in the Knowledge Graph, e.g., relationship values determined by the knowledge graph engine 256.

In some embodiments, the scoring server 250 includes an alpha relation engine 242 to obtain the strongest holding to entity relationship based on the impact array, e.g., the alpha relationship. In embodiments, the scoring server 250 includes an impact factor engine 244 to apply a weights/additive factors to articles. More specifically, the impact factor engine 244 may determine articles with impacts across multiple holdings within a portfolio and set an indicator or weight on those articles for input for modeling. Embodiments are not limited in this manner.

In embodiments, the scoring server 250 also includes a category score engine 246. The category score engine 246 may add additional a weight based on the topic of articles, e.g., the ‘business’ category may be weighted by 0.4. Moreover, the category score engine 246 determine science and technology articles add an exception. Further, no devaluation score is factored in the absence of a category by the category score engine 246. In embodiments, the scoring server 250 includes a final score engine 248 to generate and evaluate final scores based on as previously discussed utilizing equation 3. As an input, the final score engine 248 may receive data and information from the above-discussed components of the scoring server 250, the connection score, and the priority model score, as previously discussed.

Although not shown, the scoring server 250 may also include an outputting component that enables and/or provides two user interfaces, one for use by a user and another for use by a system administrator. More specifically, a user may interact with an end user client application, which runs on a mobile browser, and the user views the news feed and associated data determined and presented. The system administrator may interact with an editorial application, such as RPM, that allows the system administrator and/or a member editorial team to view the end user feed, block, pin or cluster articles and view detailed metrics relating to the scored articles. If the editorial team determines the model scored articles incorrectly, they have the ability to block that article from going to the user feed. This is also the place where the editorial team provides feedback thereby helping re-train the models.

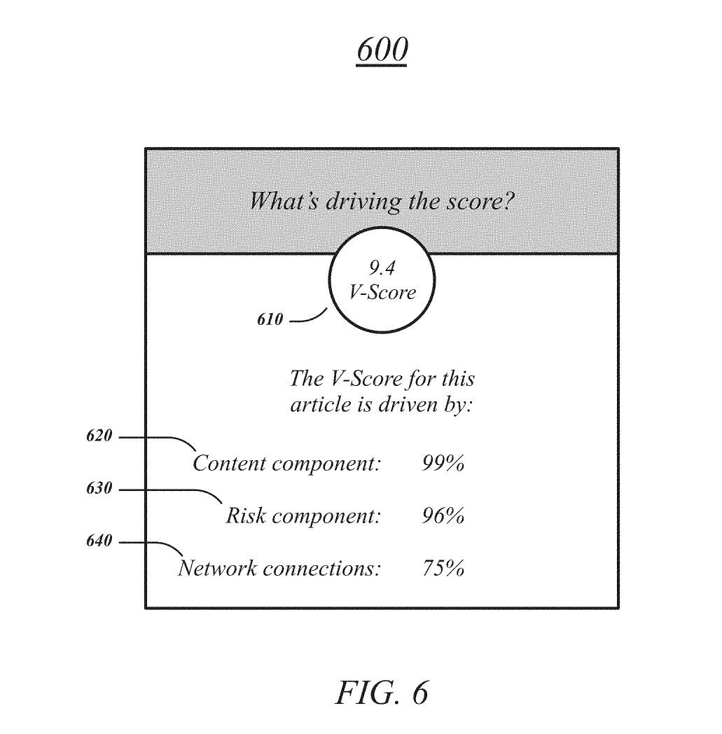

In embodiments, the article curation system 100 may present a proprietary metric (V-Score) driven news feed tailored for a portfolio. The news is sorted and presented to the user based on the V-score. The V-Score which ranges from 2-10 surfaces actionable news and also as a metric quantifies exposure to all surfaced news articles. Each article consists of the Primary Entities they are related to in the Portfolio called the Anchors. Anchors then augment to a group of holdings in the portfolio which indirectly get impacted by the news article. Each of these direct and indirect connections are represented with associated metrics. Each article may be provided for display to the user in association with the final score. For each article, a user may be presented the title, the v-score, the connections (direct and in-direct), and a number of articles in the feed and which article they are on. This information may be presented in a graphical user interface (GUI). The user may also be presented with a “score transparency” GUI that show how the scoring derived the v-score, e.g., the three components including the connection score, the priority model score, and the network and price correlation score. FIG. 6 illustrates one example of the “score transparency” GUI. A cluster engine 232 may using a clustering algorithm to organize related articles into a group for display to the user.

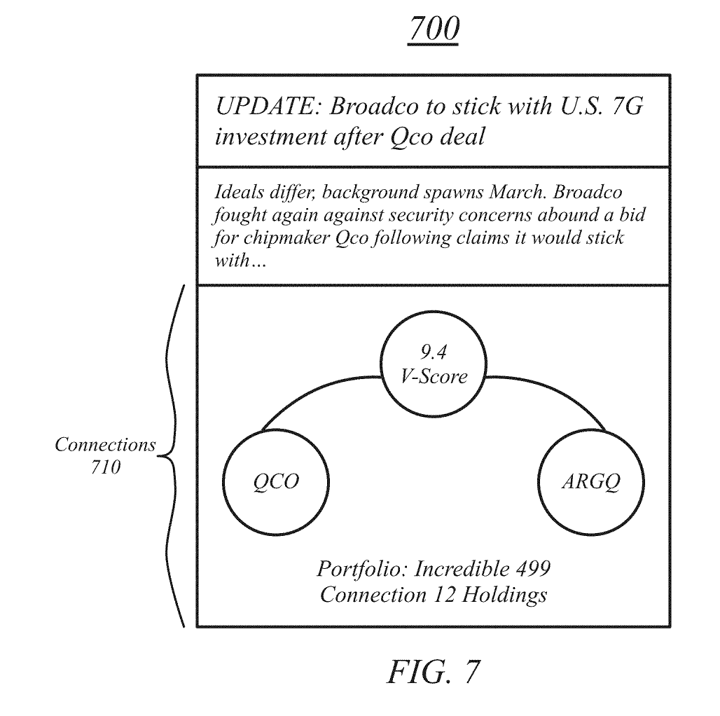

In some embodiments, the article curation system 100 may present a user with information corresponding to direct connections. For each article, the model surfaces Direct Connections or anchors. These are entities directly mentioned in the article and thus directly connected to it. The article details shows these direct connections, as illustrated in FIG. 7. Similarly, the article curation system 100 may present a user with information corresponding with the indirect connections. The model also surfaces indirect connections that are connected to the anchors. Indirect connections are surfaced based on a combination network strength and correlation to the anchor holdings. The “Explore Connections” shows the relationship between the anchor and the indirect connection including the correlation and the network relationships that the model used to rank the indirect connections.

In some embodiments, all model calculations are performed by a backend processing pipeline of article curation system 100 in order to scale and allow for a responsive output to the end user. In one example, the pipeline runs on a scalable Apache Spark processing cluster and all data values calculated by the model are stored within an article json structure which is then pushed into a mongo and an elastic cluster. The output clients simply retrieve the new feed via web services which queries the elastic storage. No calculations occur during this output phase. However, embodiments are not limited in this manner and may operating on different processing configuration.

In embodiments, the article curation system 100 may monitor and generate data quality metrics. Some of the aspect of Data quality include timeliness, validity, consistency, and integrity. For example, Portfolio data is ingested daily from truView. The ingestion process performs validity checks on key fields (ISIN, ticker, etc.) and will reject invalid records. The article curation system 100 may monitor News Data that is ingested either via search or RSS. Validity checks are performed on title/description. If key fields are missing the article will be ignored and not scored. The article curation system 100 may monitor Factset data that is ingested quarterly. Through the editorial process, if key relationships or data is found to be missing, we will supplement the data appropriately. The article curation system 100 may monitor the Model training through the editorial feedback, supervised learning is established for spam, priority model and the ontology models. The curators provide feedback/input into these models so that the models are constantly being tuned.

The article curation system 100 also enables monitoring through the RPM tool. For example, the editorial team can constantly monitor the quality of news feed and the associated direct/indirect connections, so any data inconsistencies will usually be quickly noticed.

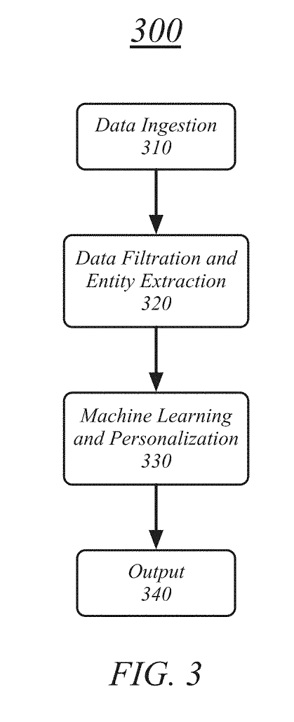

FIG. 3 illustrates an example of a processing flow 300 according to embodiments.

For example, in embodiments, the processing flow includes gathering data, e.g., performing a mass ingesting of news, social data, opinion content, and so forth during an acquiring process of data ingestion 310.

The article curation system 100 then performs data filtration and entity extraction 320. The data may be filtered during a filter process. More specifically, the most relevant results according to a portfolio may be determined. An understand process may be performed to convert information to insight.

The article curation system 100 then performs machine learning and personalization 330. The insight may be ranked based on relevance to user's portfolio impact at an analyze process.

Thereafter, an output 340 may be generated and presented to a user in the graphical user interface such that a user can take action to provide information to a client about impactful risks and opportunities. The graphical user interface may include one or more depictions of the information such as the user interfaces illustrated and described in conjunction with FIGS. 6-8.

Embodiments discussed herein may solve core problems include difficulty connecting news/information to a potential first and second order impacts on a portfolio/strategies. Other improvements include providing confidence in the quality of data presented and enabling synthesizing insights to provide to a user rapidly to drive the best action.

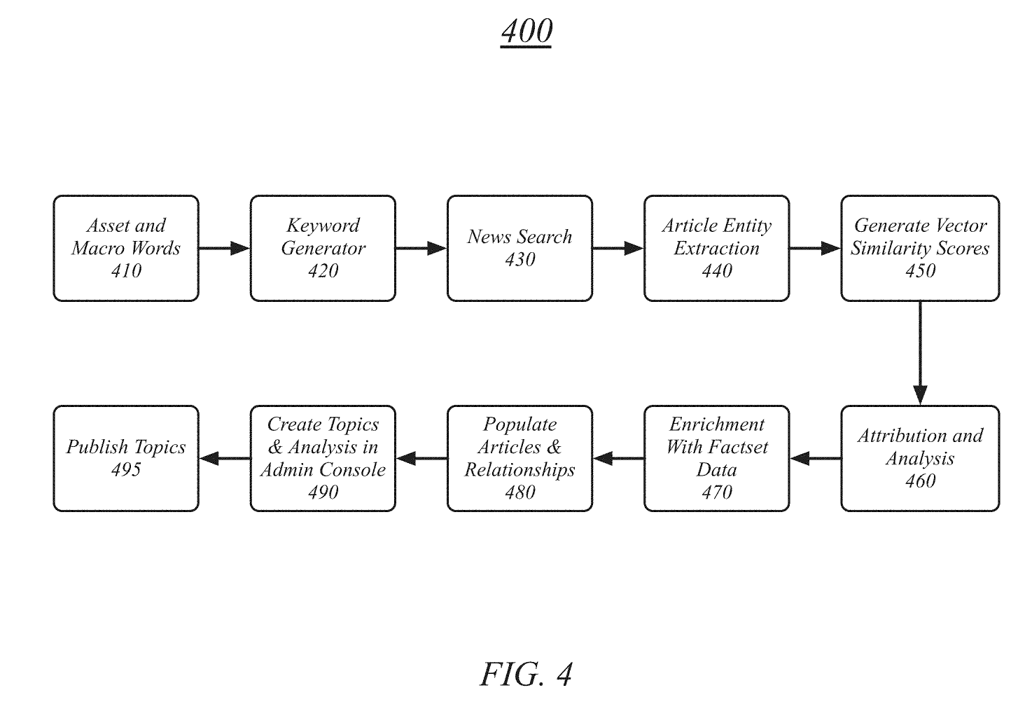

FIG. 4 illustrates an example of a processing flow 400 according to embodiments discussed herein. For examples, one or more elements illustrated in FIG. 4 may be performed by article curation system 100 discussed herein. At element one 410, embodiments include determining assets and macro topics. For example, embodiments include determining asset names and ticker symbols for a portfolio. Additional keywords for macro-topics may also be determined. At element two 420, embodiments include generating keywords. More specifically, embodiments include generating contextually similar words to companies in the portfolio using our word2vec model trained on historical news & industry knowledge (currently WSJ and Wikipedia). The machine learning method is called skip-gram modeling

In embodiments, the processing flow includes performing searching based on the keywords at element three 430. For example, a search API may be performed for each keyword and may be limited to the past 24 hours. At element four 440, embodiments include processing data through an Alchemy API to extract entities. The articles may be sent to the API and processed by the API to extract entities. These entities and other context-specific NLP taxonomy may be stored in a data store.

In embodiments, the processing flow includes generating vector similarity scores for the data at element five 450. For example, using the same word2vec model in element two, calculate the vector distance between every company in the portfolio and the article entities. The scoring determines which assets are most relevant to the article. This scoring surfaces articles with 1^{st}, 2^{nd} and 3^{rd} order importance to assets. At element six 460, embodiments include performing attribution and analysis on the data to generate scores. The scoring may be based on analyst thinking, event weighting, relevant risk metrics, and qualitative metrics. Embodiments further include performing fact set enrichment at element seven 470. For example, embodiments include enriching articles with sector & industry labels for top scored assets from FACT SET industry data.

Embodiments include populating the results in a knowledge graph and databases at element eight 480. For example, embodiments include populating the articles and their relationship to assets in our knowledge graph (neo4j) and populating the articles into our data-lake (Dynamodb) and ElasticSearch databases. Further and at element nine 490, embodiments include creating topics and analysis in an administrator console. For example, using a clustering algorithm to organize related articles. Some embodiments enable user curation for quality assurance and selective topic curation. Element ten 495 includes publishing the articles into a mobile-web based on application and presenting the information in one or more graphical user interfaces, see, e.g., FIGS. 6 and 7.

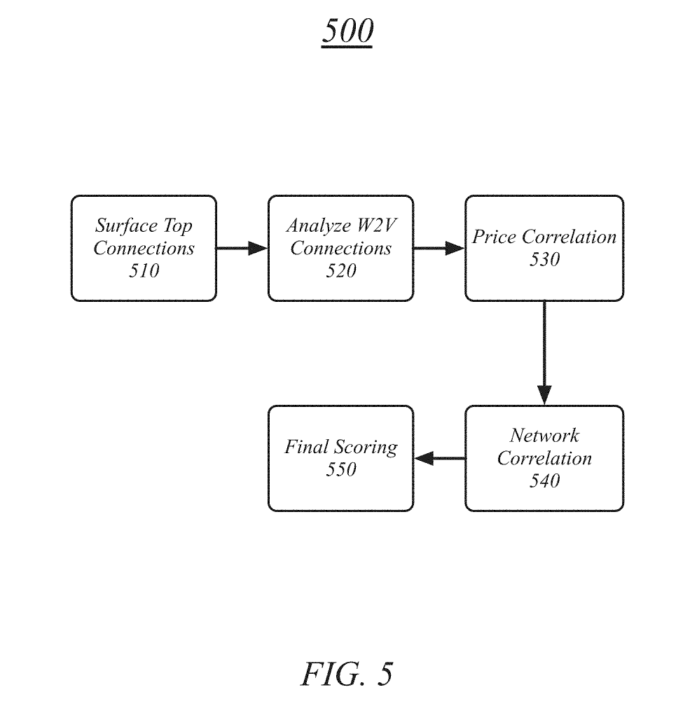

FIG. 5 illustrates an example of a processing flow 500 according to embodiments discussed herein to determine final scores. These elements may be performed to generate final scores by the final score engine 248, for example. These elements include surfacing top connections 510, analyzing W2V connections 520, determine price correlations 530, determining network correlations 540, and generating the final scoring 550. In embodiments, final score engine 248 may determine the V-score utilizing equation 3, as previously discussed.

Surfacing top connections 510 may comprise surfacing connections based on top holdings only if the top holding has a W2V score above a configurable threshold (e.g., 0.85). Analyzing W2V connections 520 may comprise keeping all holdings with a W2V score above the threshold in the impacts their current positions. Price correlation 530 may comprise comparing portfolio holding correlations to the core holding. Network correlation 540 may comprise identifying direct and shared relationships. Final scoring 550 may comprise combining price and network factors into a final score.

FIG. 6 illustrates an embodiment of a score transparency user interface 600. The score transparency user interface 600 may comprise a plurality of elements. The score transparency user interface 600 may comprise a V-score display element 610 displaying the V-score for an article. The score transparency user interface 600 may comprise a content component element 620 comprising a percentage or other information indicating the strength of the content component. The score transparency user interface 600 may comprise a risk component element 630 comprising a percentage or other information indicating a strength of the risk component. The score transparency user interface 600 may comprise a network connection element 640 comprising a percentage or other information indicating the strength of the network connections component.

FIG. 7 illustrates an embodiment of a direct connections user interface 700. The direct connections user interface 700 presents a user with information corresponding to direct connections 710. The direct connections user interface 700 comprises a user interface 700 indicating direct connections 710 for a given news article. The direct connections 710 may comprise the entities directly mentioned in the article and thus directly connected to it.

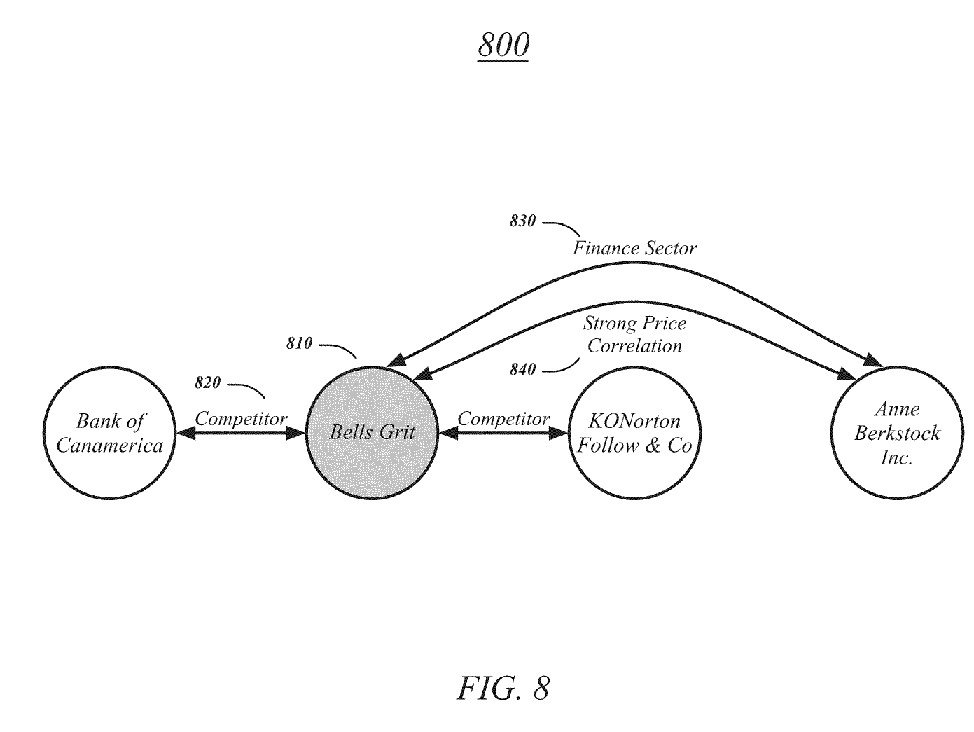

FIG. 8 illustrates an embodiment of a network effect user interface 800 indicating results generated based on processing discussed herein such as the processes discussed in conjunction with FIGS. 2-5. In the illustrated example, Bells Grit is surfaced as a core holding 810. Bank of Canamerica and KONorton Follow & Co connected through correlation and shared network relationships indicating a competitor relationship 820 between the entities. Anne Berkstock Inc. connected via correlation, but not shared relationships. The correlations comprise a finance sector correlation 830 and a strong price correlation 840 correlation. Embodiments are not limited to this example.

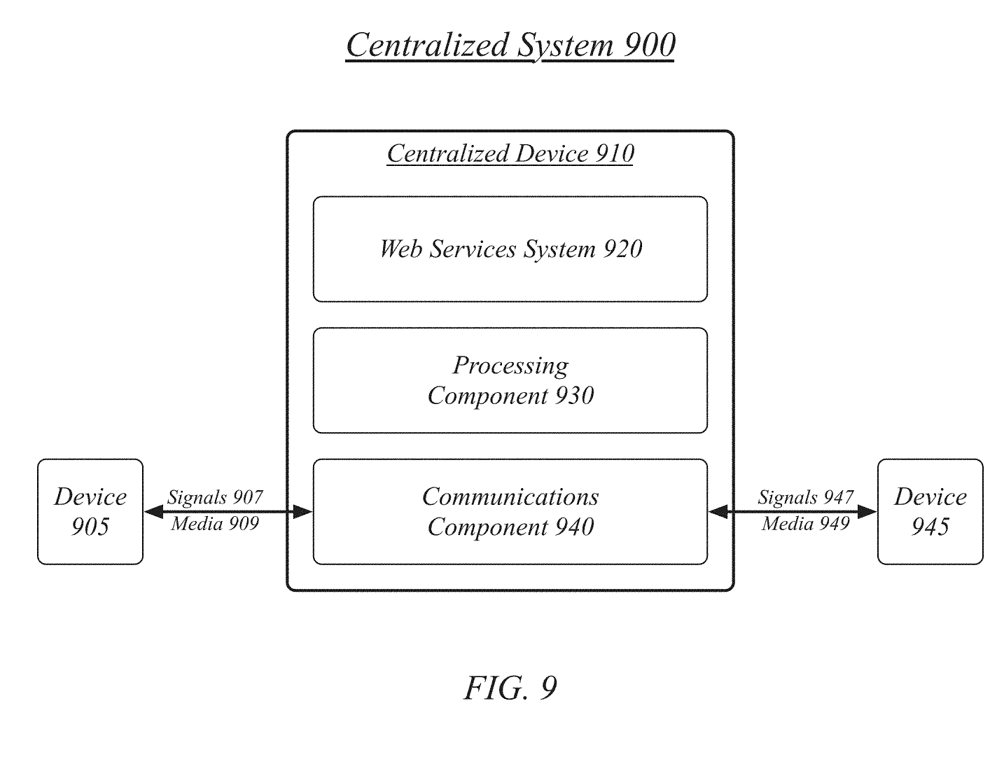

FIG. 9 illustrates a block diagram of a centralized system 900. The centralized system 900 may implement some of or all the structure and/or operations for the web services system 920 in a single computing entity, such as entirely within a single device 910. The web services system 920 may perform services or processes such as the processes discussed in conjunction with the FIGS. 1-8.

The device 910 may include any electronic device capable of receiving, processing, and sending information for the web services system 920. Examples of an electronic device may include without limitation a computer, a personal computer (PC), a desktop computer, a laptop computer, a notebook computer, a netbook computer, a handheld computer, a tablet computer, a server, a server array or server farm, a web server, a network server, an Internet server, a work station, a main frame computer, a supercomputer, a network appliance, a web appliance, a distributed computing system, multiprocessor systems, processor-based systems, wireless access point, base station, subscriber station, radio network controller, router, hub, gateway, bridge, switch, machine, or combination thereof. The embodiments are not limited in this context.

The device 910 may execute processing operations or logic for the web services system 920 using a processing component 930. The processing component 930 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 910 may execute communications operations or logic for the web services system 920 using communications component 940. The communications component 940 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 940 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 909, 949 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 910 may communicate with other devices 905, 945 over a communications media 909, 949, respectively, using communications signals 907, 947, respectively, via the communications component 940. The devices 905, 945, may be internal or external to the device 910 as desired for a given implementation. Examples of devices 905, 945 may include, but are not limited to, a mobile device, a personal digital assistant (PDA), a mobile computing device, a smart phone, a telephone, a digital telephone, a cellular telephone, ebook readers, a handset, a one-way pager, a two-way pager, a messaging device, consumer electronics, programmable consumer electronics, game devices, television, digital television, or set top box.

For example, device 905 may correspond to a client device such as a phone used by a user. Signals 907 sent over media 909 may therefore include communication between the phone and the web services system 920 in which the phone transmits a request and receives a web page in response.

Device 945 may correspond to a second user device used by a different user from the first user, described above. In one embodiment, device 945 may submit information to the web services system 920 using signals 947 sent over media 949 to construct an invitation to the first user to join the services offered by web services system 920. For example, if web services system 920 includes a social networking service, the information sent as signals 947 may include a name and contact information for the first user, the contact information including phone number or other information used later by the web services system 920 to recognize an incoming request from the user. In other embodiments, device 945 may correspond to a device used by a different user that is a friend of the first user on a social networking service, the signals 947 including status information, news, images, or other social-networking information that is eventually transmitted to device 905 for viewing by the first user as part of the social networking functionality of the web services system 920.

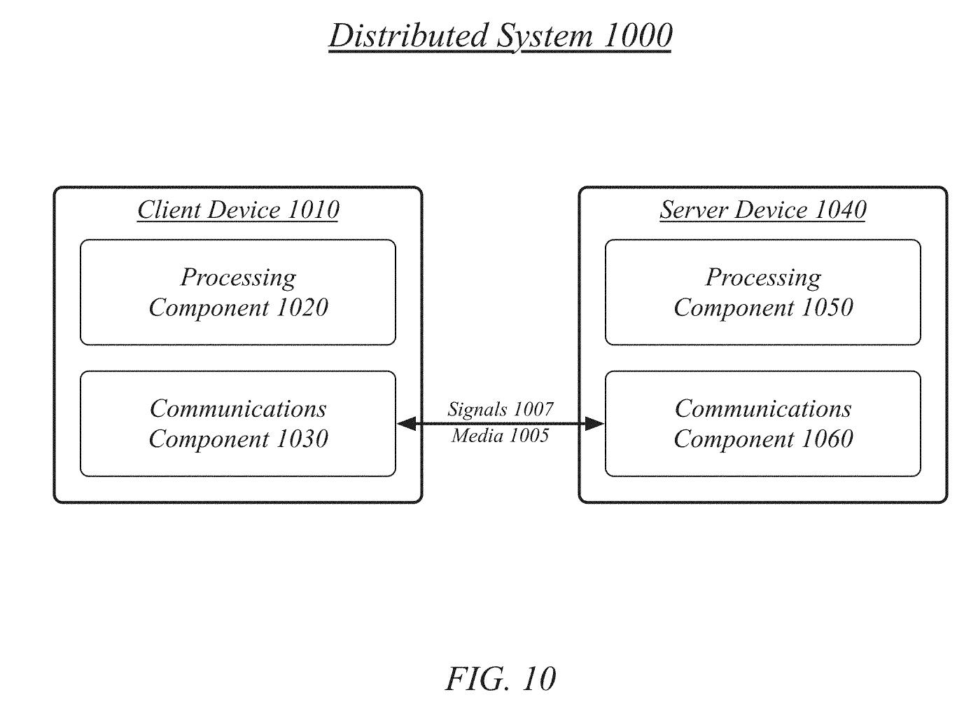

FIG. 10 illustrates a block diagram of a distributed article curation system 1000. The distributed article curation system 1000 may distribute portions of the structure and/or operations for the disclosed embodiments discussed in conjunction with FIGS. 1-9, across multiple computing entities. Examples of distributed article curation system 1000 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed article curation system 1000 may include a client device 1010 and a server device 1040. In general, the client device 1010 and the server device 1040 may be the same or similar to device 910 as described with reference to FIG. 9. For instance, the client device 1010 and the server device 1040 may each include a processing component 1020, 1050 and a communications component 1030, 1060 which are the same or similar to the processing component 930 and the communications component 940, respectively, as described with reference to FIG. 10. In another example, the devices 1010 and 1040 may communicate over a communications media 1005 using media 1005 via signals 1007.

The client device 1010 may include or employ one or more client programs that operate to perform various methodologies in accordance with the described embodiments. In one embodiment, for example, the client device 1010 may implement some processes described with respect client devices described in the preceding figures such as FIGS. 2-5.

The server device 1040 may include or employ one or more server programs that operate to perform various methodologies in accordance with the described embodiments such as the article curation system 100 shown and discussed in conjunction with FIGS. 1-2. In one embodiment, for example, the server device 1040 may implement some processes described with respect to server devices described in the preceding figures.

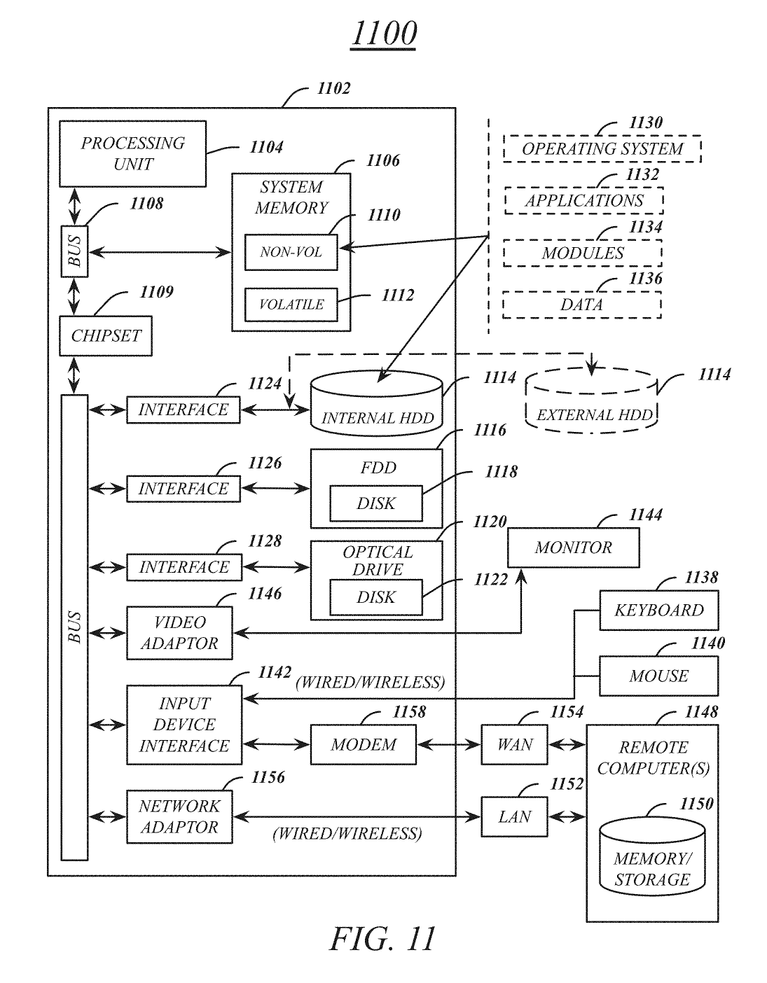

FIG. 11 illustrates an embodiment of an exemplary computing architecture 1100 suitable for implementing various embodiments as previously described in conjunction with FIGS. 1-10. In one embodiment, the computing architecture 1100 may include or be implemented as part of an electronic device. Examples of an electronic device may include those described herein. The embodiments are not limited in this context.

As used in this application, the terms “system” and “component” are intended to refer to a computer-related entity, either hardware, a combination of hardware and software, software, or software in execution, examples of which are provided by the exemplary computing architecture 1100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1100.

As shown in FIG. 11, the computing architecture 1100 includes a processing unit 1104, a system memory 1106 and a system bus 1108. In some embodiments, a system bus 1108 may interconnect the processing unit 1104 with the system memory 1106 and a chipset 1109 may interconnect a system bus 1108 with one or more other buses to interconnect the peripherals (such as interfaces 1124-1128, video adapter 1146, input device interface 1142, and/or network adaptor 1156) with the system bus 1108. In other embodiments, the system memory 1106 may couple with the processing unit 1104 via one or more direct links, the processing unit 1104 may couple with a chipset (not shown) via one or more direct links, and the chipset 1109 may couple with the peripherals through one or more other buses. In some embodiments, the direct links may comprise high-speed serial links.

The processing unit 1104 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1104.

The system bus 1108 provides an interface for system components including, but not limited to, the system memory 1106 to the processing unit 1104. The system bus 1108 can be any of several types of bus structure that may further interconnect to a memory bus (with or without a memory controller), a peripheral bus, and a local bus using any of a variety of commercially available bus architectures. Interface adapters may connect to the system bus 1108 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1100 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable storage medium, which may be read and executed by one or more processors to enable performance of the operations described herein.

The system memory 1106 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 11, the system memory 1106 can include non-volatile memory 1110 and/or volatile memory 1112. A basic input/output system (BIOS) can be stored in the non-volatile memory 1110.

The computer 1102 may include various types of computer-readable storage media in the form of one or more lower speed memory units, including an internal (or external) hard disk drive (HDD) 1114, a magnetic floppy disk drive (FDD) 1116 to read from or write to a removable magnetic disk 1118, and an optical disk drive 1120 to read from or write to a removable optical disk 1122 (e.g., a CD-ROM, DVD, or Blu-ray). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory 1110, 1112, including an operating system 1130, one or more application programs 1132, other program modules 1134, and program data 1136. In one embodiment, the one or more application programs 1132, other program modules 1134, and program data 1136 can include, for example, the various applications and/or components to implement the disclosed embodiments.

A user can enter commands and information into the computer 1102 through one or more wire/wireless input devices, for example, a keyboard 1138 and a pointing device, such as a mouse 1140. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, and so forth.

A display 1144 is also connected to the system bus 1108 via an interface, such as a video adaptor 1146. The display 1144 may be internal or external to the computer 1102. In addition to the display 1144, a computer typically includes other peripheral output devices, such as speakers, printers, and so forth.

The computer 1102 may operate in a networked environment using logical connections via wire and/or wireless communications to one or more remote computers, such as a remote computer 1148. The remote computer 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, connects to the system bus 908 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

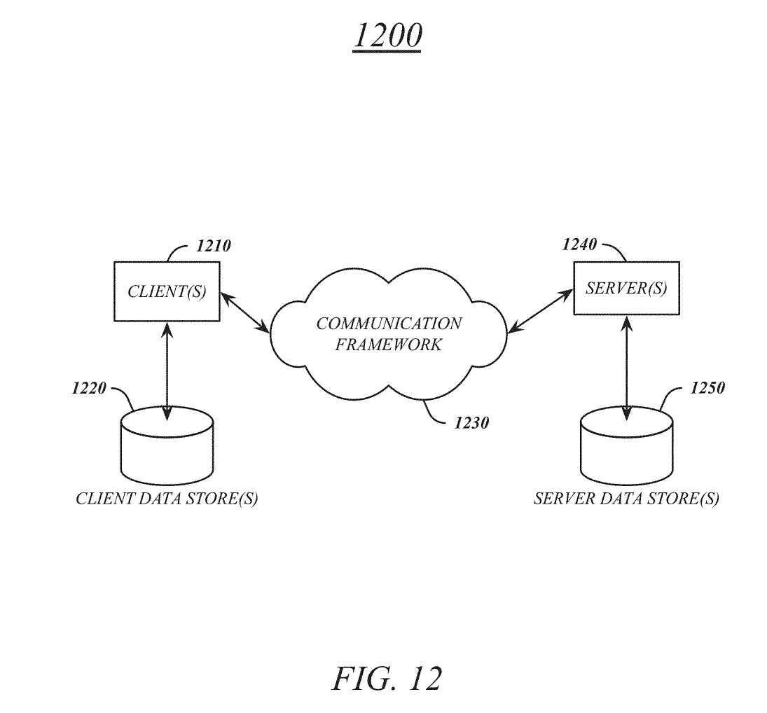

FIG. 12 illustrates a block diagram of an exemplary communications architecture 1200 suitable for implementing various embodiments as previously described. The communications architecture 1200 includes various common communications elements, such as a transmitter, receiver, transceiver, radio, network interface, baseband processor, antenna, amplifiers, filters, power supplies, and so forth. The embodiments, however, are not limited to implementation by the communications architecture 1200.

As shown in FIG. 12, the communications architecture 1200 includes one or more clients 1210 and servers 1240. The clients 1210 may implement a client device, for example. The servers 1240 may implement a server device, for example. The clients 1210 and the servers 1240 are operatively connected to one or more respective client data stores 1220 and server data stores 1250 that can be employed to store information local to the respective clients 1210 and servers 1240, such as cookies and/or associated contextual information.

The clients 1210 and the servers 1240 may communicate information between each other using a communication framework 1230. The communications framework 1230 may implement any well-known communications techniques and protocols. The communications framework 1230 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1230 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.12 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1210 and the servers 1240. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may include a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method processes. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible.

1. A computer-implemented method, comprising:
receiving an article;
analyzing the article with a priority model to generate a priority model score, the priority model comprising a supervised learning model trained on curated articles;
determining one or more entities mentioned in the article;
matching the one or more entities to one or more investment holdings based on an ontology model;
determining a portfolio related to the one or more entities;
determining a connection-risk score for the article as it relates to the portfolio, the connection-risk score reflecting the connection of the article to the portfolio and a portfolio risk of the one or more entities to the portfolio;
generating a final score for the article based on the priority model score and the connection-risk score; and
determining whether to provide the article to a user associated with the portfolio based on the final score.

2. The method of claim 1, comprising:
generating a plurality of keywords for the portfolio;
performing a keyword search using the plurality of keywords to generate a plurality of candidate articles;
receiving the plurality of candidate articles;
performing a checksum indexing of the plurality of candidate articles to identify duplicate articles of the plurality of candidate articles; and
analyzing the article for portfolio relevance in response to determining the article is not one of the duplicate articles.

3. The method of claim 1, further comprising:
receiving user article evaluation metrics from user interactions with displayed articles; and
updating the priority model based on the received user article evaluation metrics.

4. The method of claim 1, wherein matching the one or more entities to one or more investment holdings based on the ontology model comprises mapping between the one or more entities and the one or more investment holdings based on one or more of entity aliases, parent company relationships, and senior executive relationships.

5. The method of claim 1, wherein determining the connection-risk score for the article as it relates to the portfolio comprises combining two or more of a connection type weight factor, a number of shared relationships, a return correlation, a network proportionality constant, and a correlation proportionality constant.

6. The method of claim 1, wherein determining the connection-risk score for the article as it relates to the portfolio comprises determining vector distances between the one or more entities mentioned in the article and one or more assets in the portfolio.

7. The method of claim 1, further comprising:
providing the article to a user interface of a user client application running on a web browser, the article provided for display in association with the final score.

8. An apparatus, comprising:
an ingestion engine operative to receive an article;
a priority model engine operative to analyze the article with a priority model to generate a priority model score, the priority model comprising a supervised learning model trained on curated articles;
an entity recognition engine operative to determine one or more entities mentioned in the article;
an ontology engine operative to match the one or more entities to one or more investment holdings based on an ontology model; and determine a portfolio related to the one or more entities;
a connection and risk engine operative to determine a connection-risk score for the article as it relates to the portfolio, the connection-risk score reflecting the connection of the article to the portfolio and a portfolio risk of the one or more entities to the portfolio; and
a score server operative to generate a final score for the article based on the priority model score and the connection-risk score; and determine whether to provide the article to a user associated with the portfolio based on the final score.

9. The apparatus of claim 8, further comprising:
a keyword generator operative to generate a plurality of keywords for the portfolio;
a search server operative to perform a keyword search using the plurality of keywords to generate a plurality of candidate articles; and
the ingestion engine operative to receive the plurality of candidate articles;
perform a checksum indexing of the plurality of candidate articles to identify duplicate articles of the plurality of candidate articles; and analyze the article for portfolio relevance in response to determining the article is not one of the duplicate articles.

10. The apparatus of claim 8, further comprising:
the priority model engine operative to receive user article evaluation metrics from user interactions with displayed articles; and update the priority model based on the received user article evaluation metrics.

11. The apparatus of claim 8, wherein matching the one or more entities to one or more investment holdings based on the ontology model comprises mapping between the one or more entities and the one or more investment holdings based on one or more of entity aliases, parent company relationships, and senior executive relationships.

12. The apparatus of claim 8, wherein determining the connection-risk score for the article as it relates to the portfolio comprises combining two or more of a connection type weight factor, a number of shared relationships, a return correlation, a network proportionality constant, and a correlation proportionality constant.

13. The apparatus of claim 8, wherein determining the connection-risk score for the article as it relates to the portfolio comprises determining vector distances between the one or more entities mentioned in the article and one or more assets in the portfolio.

14. The apparatus of claim 8, further comprising:
an outputting component operative to provide the article to a user interface of a user client application running on a web browser, the article provided for display in association with the final score.

15. At least one non-transitory computer-readable storage medium comprising instructions that, when executed, cause a system to:
receive an article;
analyze the article with a priority model to generate a priority model score, the priority model comprising a supervised learning model trained on curated articles;
determine one or more entities mentioned in the article;
match the one or more entities to one or more investment holdings based on an ontology model;
determine a portfolio related to the one or more entities;
determine a connection-risk score for the article as it relates to the portfolio, the connection-risk score reflecting the connection of the article to the portfolio and a portfolio risk of the one or more entities to the portfolio;
generate a final score for the article based on the priority model score and the connection-risk score; and
determine whether to provide the article to a user associated with the portfolio based on the final score.

16. The non-transitory computer-readable storage medium of claim 15, comprising further instructions that, when executed, cause a system to:
generate a plurality of keywords for the portfolio;
perform a keyword search using the plurality of keywords to generate a plurality of candidate articles;
receive the plurality of candidate articles;
perform a checksum indexing of the plurality of candidate articles to identify duplicate articles of the plurality of candidate articles; and
analyze the article for portfolio relevance in response to determining the article is not one of the duplicate articles.

17. The non-transitory computer-readable storage medium of claim 15, comprising further instructions that, when executed, cause a system to:
receive user article evaluation metrics from user interactions with displayed articles; and
update the priority model based on the received user article evaluation metrics.

18. The non-transitory computer-readable storage medium of claim 15, wherein matching the one or more entities to one or more investment holdings based on the ontology model comprises mapping between the one or more entities and the one or more investment holdings based on one or more of entity aliases, parent company relationships, and senior executive relationships.

19. The non-transitory computer-readable storage medium of claim 15, wherein determining the connection-risk score for the article as it relates to the portfolio comprises combining two or more of a connection type weight factor, a number of shared relationships, a return correlation, a network proportionality constant, and a correlation proportionality constant.

20. The non-transitory computer-readable storage medium of claim 15, wherein determining the connection-risk score for the article as it relates to the portfolio comprises determining vector distances between the one or more entities mentioned in the article and one or more assets in the portfolio.
